(19) United States
(12) Patent Application Publication
(10) Pub. No.: US 2023/0014279 A1
(43) Pub. Date: Jan. 19, 2023

(54) POROUS SILICON CHARGED PARTICLE, X-RAY, GAMMA-RAY AND THERMAL NEUTRON ATTENUATRS AND METHODS OF MANUFACTURING THE SAME

(71) Applicant: Vladimir Kochergin, Christiansburg, VA (US)

(72) Inventor: Vladimir Kochergin, Christiansburg, VA (US)

(21) Appl. No.: 17/377,800

(22) Filed: Jul. 16, 2021

(51) Int. Cl. G01T 1/24

(52) U.S. Cl. CPC G01T 1/24

(57) ABSTRACT

The present invention relates to charged particle, X-ray, gamma ray and or thermal neutron attenuators on the basis of micro structured semiconductor and method of making the same. In more detail, the present invention is related to three-dimensionally microstructured charged particle, X-ray, gamma ray and or thermal neutron attenuators. The attenuators of the present invention will improve the performance of telescopes, radiology equipment, nondestructive evaluation equipment and proton therapy equipment.

### CROSS-REFERENCES TO RELATED APPLICATIONS

63073582, Attorney Docket Number 612020MICROX

### STATEMENT REGARDING FEDERALLY SPONSORED RESEARCH OR DEVELOPMENT

The invention was made with Government (NASA) support and the Government (NASA) has certain rights to this invention.

### FIELD OF THE INVENTION

The present invention relates to charged particle, X-ray, gamma ray and or thermal neutron attenuators made on the basis of micro structured semiconductors. In more detail the attenuators of the present invention are “flattening” the incident X-ray, gamma-ray or thermal neutron energy spectrum to match it to the responsivity curve of the detector thus allowing wider energy range measurement with a given detector. The charged particle, X-ray, gamma ray and or thermal neutron attenuators of the present invention will improve the performance of telescopes, radiology equipment, and nondestructive evaluation equipment.

### BACKGROUND OF THE INVENTION

X-ray neutral density (ND) filters, also known as attenuator,) have been known for decades and are heavily used in both commercial applications (radiology) and multiple NASA missions targeting X-ray and particle detection. A number of applications require attenuators for hard x-rays to provide broad (1 KeV to 100 KeV or more) attenuation by a factor of 10 to 1000 or more to “flatten” the energy spectrum of incoming X-rays. For a nonlimiting example, the solar X-ray flux, exhibits 2 orders of magnitude decline from ˜1 KeV to just 10 KeV, and around 4 orders of magnitude drop between the 1 KeV and 100 KeV, making it impossible to detect X-rays with 1-100 KeV energies with a single detector unfiltered. The situation with other astronomical objects is qualitatively similar, while more complex due to wide variation of the X-ray peak energy due to large variations in plasma temperatures of different astronomical objects and thus the necessity of an even wider energy range X-ray detection is needed.

The most widely used X-ray attenuation approach to date is to use very thin foil of different materials. Unfortunately, such an approach completely suppresses the low energy (few KeV or below) photons, which are very valuable for both solar observation, as well detection of other astronomical objects. Also, such X-ray ND filters cannot provide sufficient control over the level of blocking over a wide energy range of 1 KeV to 100 KeV needed by NASA missions. Other techniques, commonly used for X-ray and particle attenuation, e.g., gas attenuators, not only could not offer flat density over the wide energy range but also are relatively bulky and heavy for space applications.

Similar problems exist in applications involving charged particles and thermal neutrons.

To conclude, new designs of charged particle, X-ray, gamma and/or thermal neutron attenuator devices and methods of manufacturing the same are needed.

### SUMMARY OF THE INVENTION

It is an object of the present invention to provide a new design and method of fabrication of charged particle, X-ray, gamma and/or thermal neutron attenuator devices on the basis of porous Silicon material with improved mechanical and environmental stability, improved performance and practical/cost-effective method of fabrication of such a devices.

According to the first embodiment of the present invention, an improved charged particle, X-ray, gamma and/or thermal neutron attenuator consists of the at least one layer of three-dimensionally structured substrate having the host material with surface (or walls) and removed material, or pores of predetermined size, shape and arrangement, with at least one layer of another material deposited on the pore walls, with properties and thicknesses chosen such as the structure possess desired absorption properties over the desired energy range. The porous substrate according to this embodiment of the present invention is fabricated by means of electrochemical etching of single crystalline silicon wafer. By adjusting the pore size, spacing and pore wall coating thickness the controllable attenuation in the range of 0.2:1 to >100:1 can be achieved over wide energy range.

According the second embodiment of the present invention, an improved charged particle, X-ray, gamma ray and/or thermal neutron attenuator component consists of the at least two layers of three-dimensionally structured substrates as disclosed in first embodiment of the present embodiment. According to the second embodiment, each layer has substantially (at least 2 times) different pore sizes and pitches (periods) in each of the layer, such as multiple pores in subsequent layer can be positioned in front of each pore in a previous layer. With such an attenuator design attenuation in excess of 10,000:1 can be readily achieved over the energy range. The method of fabrication of each layer of microporous Si is essentially the same as discussed in relation to the first embodiment of the present invention. The advantage of such an attenuator design is very strong attenuation available particularly at low to medium particle or wave energies combined with relaxed alignment requirements between the layers in the attenuator. For a nonlimiting example of X-ray attenuator such a design is particularly advantageous for strong attenuation up to ˜20 KeV energy range.

According the third embodiment of the present invention, an improved charged particle, X-ray, gamma-ray and/or thermal neutron attenuator component consists of the at least two layers of three-dimensionally structured substrates as disclosed in relation to the first embodiment. According to this embodiment, each layer has substantially the same pore sizes and pitches (periods) in each of the layer, with each layer angularly rotated with respect to the previous layer by a predetermined angle. With such an attenuator the Moire pattern will be observed in transmission with periodicity defined by the pore array period and angle of rotation. Thus, the angle of rotation and pore period should be preferably selected such as the Moire pattern period is substantially smaller than the cross-section of the detector or detector pixel. With such an attenuator design attenuation in excess of 1,000:1 can be readily achieved over the energy range. The method of fabrication of each layer of macroporous Si is essentially the same as discussed in relation to the first embodiment of the present invention. The advantage of such an attenuator design is very strong attenuation available particularly at low to medium particle or wave energies combined with relaxed alignment requirements between the layers in the attenuator, and simplicity of manufacturing (the same process is used for each layer in the stack). For a nonlimiting example of X-ray attenuator such a design is particularly advantageous for strong attenuation up to ˜200 KeV energy range.

According the fourth embodiment of the present invention, an improved charged particle, X-ray, gamma and/or thermal neutron attenuator component consists of the at least two layers of three-dimensionally structured substrates as disclosed in first aspect of the present embodiment. According this embodiment, each layer has substantially similar but not the same pitches (periods) in each of the layer (for a nonlimiting example 11.5 μm×11.5 μm and 12 μm×12 μm). With such an attenuator the Vernier pattern will be observed in transmission with periodicity defined by the pore array periods in individual layers. Thus, the difference in pore array periods in individual layers should be preferably selected such as the Vernier patten period is substantially smaller than the cross-section of the detector or detector pixel. With such an attenuator design attenuation in excess of 1,000:1 can be readily achieved over the energy range. The method of fabrication of each layer of macroporous Si is essentially the same as discussed in relation to the first embodiment of the present invention. The advantage of such an attenuator design is very strong attenuation available particularly at low to medium particle or wave energies combined with relaxed alignment requirements between the layers in the attenuator, and simplicity of manufacturing (the same process is used for each layer in the stack, with just different photolithography patterning of the etch pit arrays). For a nonlimiting example of X-ray attenuator such a design is particularly advantageous for strong attenuation up to ˜200 KeV energy range.

### BRIEF DESCRIPTION OF THE DRAWINGS

These and other features and advantages of presently preferred non-limiting illustrative exemplary embodiments will be better and more completely understood by referring to the following detailed description in connection with the drawings, of which:

FIG. 1 is an exemplary diagrammatic drawing of the charged particle, X-ray, gamma-ray and/or thermal neutron attenuator according to the first embodiment of the present invention;

FIG. 2 is an exemplary diagrammatic drawing of the charged particle, X-ray, gamma-ray and/or thermal neutron attenuator according to the second embodiment of the present invention;

FIG. 3 is a plot showing X-ray transmittance spectra through attenuator according to the second embodiment of the present invention, black dots are experimentally recorded transmittance values while black curve is model prediction;

FIG. 4 is an exemplary diagrammatic drawing of the charged particle, X-ray, gamma-ray and/or thermal neutron attenuator according to the third embodiment of the present invention;

FIG. 5 is a plot showing X-ray transmittance spectra through attenuator according to the third embodiment of the present invention, black dots are experimentally recorded transmittance values while black curve is model prediction;

FIG. 6a is an exemplary schematic drawing of the charged particle, X-ray, gamma-ray and/or thermal neutron attenuator according to the fourth embodiment of the present invention;

FIG. 6b is an exemplary diagrammatic drawing of the charged particle, X-ray, gamma-ray and/or thermal neutron attenuator according to the fourth embodiment of the present invention.

### DETAILED DESCRIPTION OF THE INVENTION

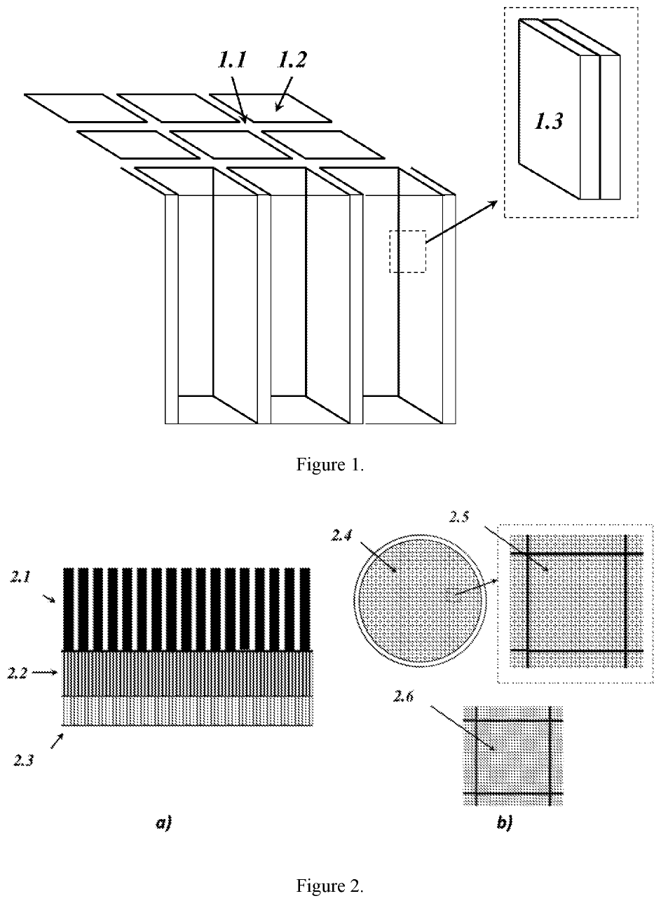

According to the first embodiment of the present invention the improved charged particle, X-ray, gamma ray and/or thermal neutron attenuator component on the basis of microporous Silicon, illustrated in FIG. 1, consists of the at least one layer of three-dimensionally structured substrate having the host material with surface (or walls) 1.1 and removed material, or pores 1.2 of predetermined size, shape and arrangement, with at least one layer of another material 1.3 deposited on the pore walls, with properties and thicknesses chosen such as the structure possess desired absorption properties over the desired energy range. The porous substrate according to this embodiment of the present invention is fabricated by means of electrochemical etching of single crystalline silicon wafer. For a nonlimiting example, said substrate can comprise a layer of macroporous silicon electrochemically etched on silicon substrate by methods known to those skilled in the art with pore aspect ratio in the range of 10 to 1000 and pore cross-section in the range of 200 nm and 50 μm. The pore walls can be additionally smoothed by adding additional anisotropic wet chemical etching step after the electrochemical etching step. The conformal deposition of at least one layer of material 1.3 conformally coating the pores walls can be performed by one or more techniques selected from the group consisted of Chemical Vapor Deposition (CVD) technique or some of its variations (such as, for a nonlimiting example Low Pressure CVD, or Metal Organic CVD), by Atomic Layer Deposition (ALD), by electrochemical and/or electroless plating. The attenuation in such a devise is achieved by absorption of the particles or waves in attenuator material (e.g., neutrons, protons, alpha-particles, etc.) or waves (X- and gamma-rays) in the coated pore wall, and geometrical transmission of the particles or waves through noncoated fraction of the pores. By adjusting the pore size, spacing and pore wall coating thickness the controllable attenuation in the range of 0.2:1 to >100:1 can be achieved over wide energy range. For a nonlimiting example of X-rays, such an attenuation can be achieved in the range of few eV to at least 30 KeV, and, in the case of, for nonlimiting example, Au, W or other high atomic layer material coating on the pore walls, up to 100 KeV and beyond.

For a nonlimiting example, the macroporous silicon is grown on p-doped (100) oriented double side polished silicon substrate with resistivity in the range of 30 and 100 Ohm cm with preliminary fabricated array of depressions or etch pits, said etch pits being fabricated by thermal oxidation of silicon wafer, photolithography, chemical etching of oxide layer through photoresist mask with reactive ion etching and then etching said etch pits in 40% KOH aqueous solution at 60 to 100° C. temperature with oxide being removed in HF solution after etch pit definition. Said silicon wafer with defined etch pits is being coated by the contact layer from the back side (i.e., the side which does not have the etch pits) and being placed in electrochemical etching cell with electrolyte made of 5 to 10% HF, 10 to 30% ethanol and 60 to 85% diemethylsulfoxide and the current density of between 2 mA/cm² to 20 mA/cm² being applied for 30 min to 20 hours, when the macroporous silicon layer is being etched. According to this illustrative example, after the completion of electrochemical etching the backside electric contact layer is being stripped by wet chemical etching (for example, if the back contact is of gold, Aqua Regina can be used). Further, the pore walls can be smoothened by exposing the etched macroporous silicon layer to diluted KOH/H₂O/ethanol solution at temperatures between 8° C. and 60° C. The wafer with formed macroporous silicon layer can be then placed in Atomic Layer Deposition machine and Ni layer with, for a nonlimiting example, 100 Å to 5000 Å thickness, followed by Au electroless plating, for a nonlimiting example between 250 nm and 2,000 nm, with Bright Electroless Gold from Transene Company Inc. at the temperatures between 80° C. and 98° C. Alternatively, the pore wall coating can be performed by electroless plating of Ni with, for a nonlimiting example, Nickelex solution from Transene Company Inc. at the temperatures between 70° C. and 93° C. followed by Au electroless plating, for a nonlimiting example between 250 nm and 2,000 nm, with Bright Electroless Gold from Transene Company Inc. at the temperatures between 80° C. and 98° C. It should be noted that other materials can be deposited either by ALD, CVD and/or electroless plating techniques (including but not limited to Ir, Pt, Bi, etc.). Follow on annealing also can be used to anneal out the defects especially after ALD or CVD of Ni layer.

According to the second embodiment of the present invention, illustrated in FIG. 2a, improved charged particle, X-ray, gamma ray and/or thermal neutron attenuator component consists of the at least two layers (called a “stack”) of three-dimensionally structured substrates as disclosed in first aspect of the present embodiment, 2.1 and 2.2, and optionally more layers can be used (such as a layer 2.3). Each layer has substantially (at least 2 times) different pore sizes and pitches (periods) in each of the layer, as illustrated in FIG. 2a and FIG. 2b such as multiple pores in subsequent layer can be positioned with each pore in previous layer.

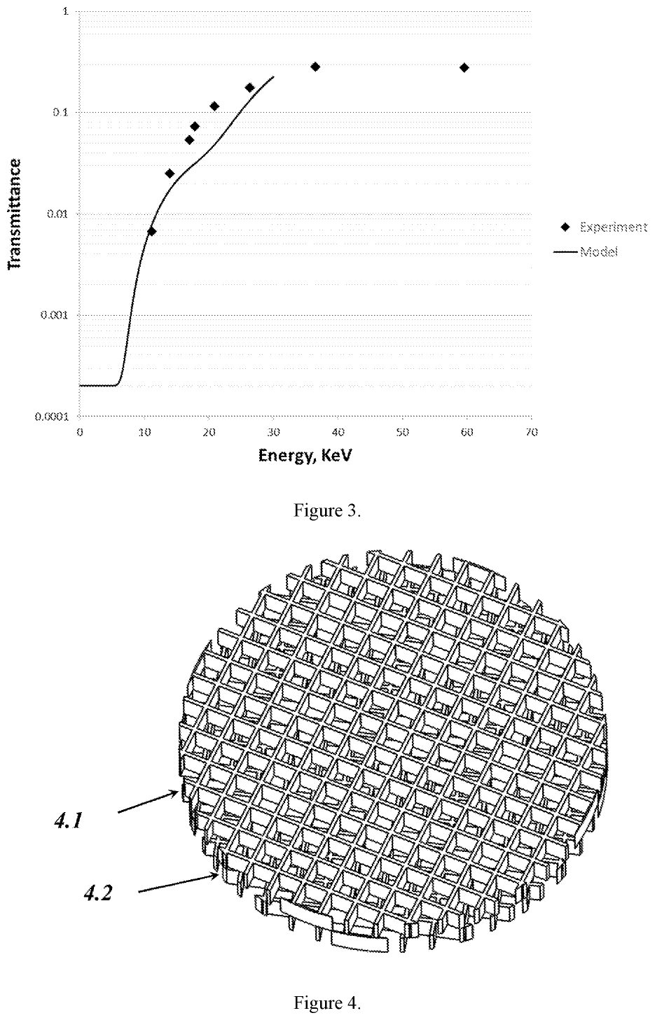

With such an attenuator design attenuation in excess of 10,000:1 can be readily achieved over the energy range, as confirmed by experimental plot in FIG. 3 which shows the X-ray transmission through two-layer attenuator, first layer comprising Ni/Au coated microporous Si membrane with 12 μm×12 μm period, 10 μm×10 μm square pores, 500 μm thick, and 2^{nd} layer comprising uncoated macroporous Si membrane with 1.5 μm×1.5 μm pores on triangular lattice with 2.2 μm period, 180 μm thick. The method of fabrication of each layer of microporous Si is essentially the same as discussed in relation to the first embodiment of the present invention. The advantage of such an attenuator design is very strong attenuation available particularly at low to medium particle or wave energies combined with relaxed alignment requirements between the layers in the attenuator. For a nonlimiting example of X-ray attenuator such a design is particularly advantageous for strong attenuation up to ˜20 KeV energy range.

To estimate the X-ray attenuation of attenuator of the present embodiment, let's assume that such an attenuator is made of i=1 . . . n layers, each layer in the attenuator has thickness tᵢ and is composed of j=1 . . . m materials each material having filling fraction f_{i,j}, porosity pᵢ=1−Σⱼf_{i,j} and mass attenuation coefficient μ_{i,j}(E). For a nonlimiting example, the layer with 10 μm×10 μm pores with 12 μm×12 μm pitch, conformally coated with 1 μm Ni layer and 0.35 μm Au layer would correspond to fₛᵢ=0.44, f_{Ni}=0.25, f_{Au}=0.074 and p=0.37. The normal incidence, averaged over the surface of the layer transmission through such a layer will be:

$${T}_{( i )} ( E ) = {p}_{( i )} + {\sum }_{j} {f}_{i , j} {e}^{- {μ}_{( i , j )} ( E ) {t}_{( i )}}$$

The total transmission through a stack averaged over the area of the detector pixel at normal incidence can be reasonably approximated as the product of the transmittances of individual layers:

$$T ( E ) = {\prod }_{i} {T}_{( i )} ( E ) = {\prod }_{i} [ {p}_{( i )} + {\sum }_{j} {f}_{i , j} {e}^{- {μ}_{( i , j )} ( E ) {t}_{( i )}} ]$$

For pure Si with no high Z coatings this equation can be further simplified to:

$$T ( E ) = {\prod }_{i} {T}_{( i )} ( E ) = {\prod }_{i} [ {p}_{( i )} + {f}_{i} {e}^{- {μ}_{Si} ( E ) {t}_{( i )}} ]$$

Which can be further simplified for the case of low energy photons (E<2 keV, where e^{-μ}^{_{(f)}}^{t}^{₍ⱼ₎}≈0) to

$${lim}_{E ⟶ 0} T ( E ) = \prod {p}_{( i )} ,$$

thus resulting in absorbance of A=1−T=1−Πp₍ᵢ₎.

For normal incidence plane parallel X-ray beams this approximation gives pretty intuitive guide to design of attenuators with controllable low energy attenuation: for example, if one needs 4 orders of magnitude low energy X-ray blocking (low energy transmission of 10⁻⁴), and one starts with the porosity p equal to, for example, 0.25, the same for all layers in the attenuator, one needs logₚT=log_{0.25}10⁻⁴≈7 layers.

Ability to choose the thicknesses of individual layers in the stack, as well as the ability to conformally coat holes in Si by different materials with techniques such as electroless plating, low pressure chemical vapor deposition (LPCVD) or atomic layer deposition (ALD) provides the opportunity to not only control the low energy attenuation but also the shape of the attenuation curve. With high atomic number pore wall coating one can extend attenuation to 10 s and even 100 s of keV if needed. Moreover, such a control may provide the opportunity to more or less exactly match the expected X-ray emission spectrum of the body being monitored, thus nearly perfectly “flattening” the X-ray spectrum reaching the detector.

It should be noted that practical X-ray beams have some angular distribution, and porous silicon attenuators of the present invention have significant angular dependence of attenuation. While exact calculations of angular dependences of particular stacks is done numerically, to have an intuitive understanding the following approximation of the angular dependence of the transmission through the porous layer with hole cross-section d₍ᵢ₎ can be made:

$${T}_{( i )} ( E , θ ) = \{ \begin{matrix}( {p}_{( i )} + {\sum }_{j} {f}_{i , j} {e}^{- {μ}_{( i , j )} ( E ) {t}_{( i )}} ) \frac{{d}_{( i )} - {t}_{( i )} \vert tan θ \vert}{{d}_{( i )}} + {F}_{( i )} ( E , θ ) \frac{{t}_{( i )} \vert tan θ \vert}{{d}_{( i )}} , θ < {tan}^{- 1} [ \frac{{d}_{( i )}}{{t}_{( i )}} ] \\ {F}_{( i )} ( E , θ ) , θ > {tan}^{- 1} [ \frac{{d}_{( i )}}{{t}_{( i )}} ]\end{matrix}$$

Where

$${F}_{( i )} ( E , θ ) = {\prod }_{j} {e}^{- \frac{{μ}_{( L , j )} ( E ) {t}_{( i )} {f}_{i , j}}{cos θ}} .$$

In the low energy limitation (E<2 keV) this simplifies to:

$${T}_{( i )} ( E , θ ) = \{ \begin{matrix}{p}_{( i )} \frac{{d}_{( i )} - {t}_{( i )} \vert tan θ \vert}{{d}_{( i )}} , θ < {tan}^{- 1} [ \frac{{d}_{( i )}}{{t}_{( i )}} ] \\ 0 , θ > {tan}^{- 1} [ \frac{{d}_{( i )}}{{t}_{( i )}} ]\end{matrix}$$

with total transmission through the stack being T(E, θ)=ΠᵢT₍ᵢ₎(E, θ). For a nonlimiting illustrative example, let's consider the stack with each lager having the same pore aspect ratio 500 μm/10 μm=50 (corresponding to field of view of 1.15°). In such a case, the 3-layer attenuator of the present embodiment, each having porosity of 0.25, at 0.5° angle of incidence will be attenuated by a factor of 358, compared to just a factor of 64 for a plane parallel beam at normal incidence.

It is worth noting that attenuator design of the present embodiment permits maintaining the field of view of the attenuator at low photon or particle energies. For a nonlimiting example, if each porous layer in the stack has the same field of view the field of view of the stack at low energies will be the same as of each layer in the stack. Let's consider an example of attenuator with three layers, first layer with 17 μm pores, 170 μm thick, 2^{nd} layer with 10 μm pores, 100 μm thick, and the 3^{rd} layer with 2 μm pores, 20 μm thick, in this case the field of view at low photon energies (below ˜10 keV for pure Si attenuator) of the stack will be the same as the field of view of each layer, 5.7°. In general, the low photon (or particle) energy field of view in the stack is defined by the field of view of the layer with the highest aspect ratio holes.

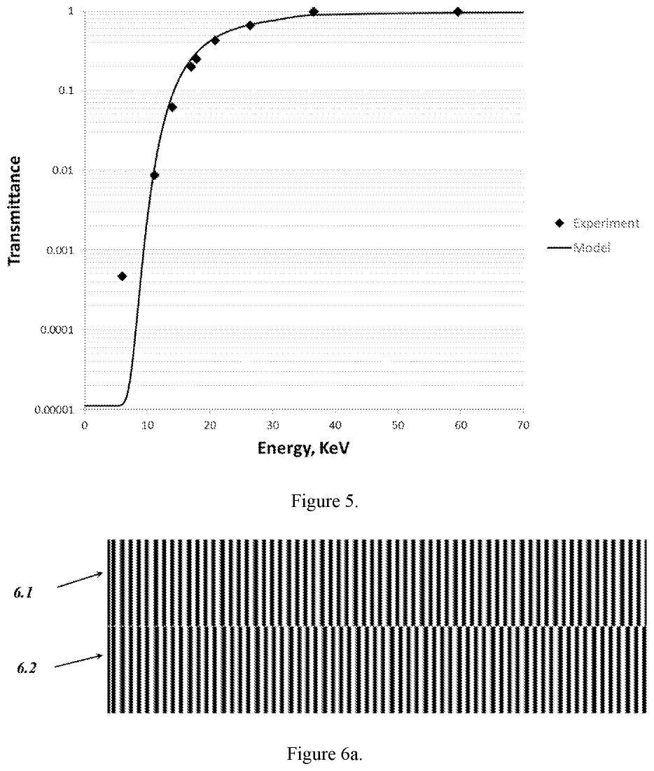

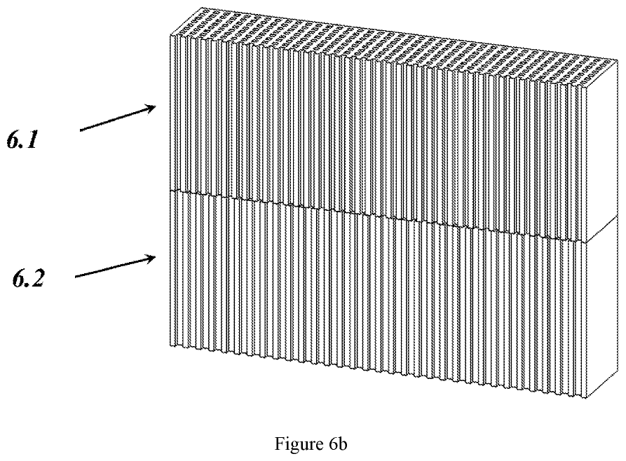

According to the third embodiment of the present invention, illustrated in FIG. 4, an improved charged particle, X-ray, gamma ray and/or thermal neutron attenuator component consists of the at least two layers of three-dimensionally structured substrates as disclosed in first embodiment, 4.1 and 4.2, each layer has substantially the same pore sizes and pitches (periods) in each of the layer, with each layer angularly rotated with respect to the previous layer by a predetermined angle. With such an attenuator the Moire pattern will be observed in transmission with periodicity defined by the pore array period and angle of rotation. Thus, the angle of rotation and pore period should be preferably selected such as the Moire patten period is substantially smaller than the cross-section of the detector or detector pixel. For a nonlimiting example of 250 μm×250 μm pixel size and 12 μm×12 μm periodicity of pore array, the angle of rotation angle of 13° or larger is desired. With such an attenuator design attenuation in excess of 1,000:1 can be readily achieved over the energy range, as confirmed by experimental plot in FIG. 5 which shows the X-ray transmission through four-layer attenuator, all layers comprising uncoated macroporous Si membrane with 12 μm×12 μm period, 10 μm×10 μm square pores, 500 μm thick, rotated by 10° with respect to each other. The method of fabrication of each layer of macroporous Si is essentially the same as discussed in relation to the first embodiment of the present invention. The advantage of such an attenuator design is very strong attenuation available particularly at low to medium particle or wave energies combined with relaxed alignment requirements between the layers in the attenuator, and simplicity of manufacturing (the same process is used for each layer in the stack). For a nonlimiting example of X-ray attenuator such a design is particularly advantageous for strong attenuation up to ˜200 KeV energy range.

According to the fourth embodiment of the present invention, illustrated in FIGS. 8a and 8b, improved charged particle, X-ray, gamma ray and/or thermal neutron attenuator component consists of the at least two layers of three-dimensionally structured substrates as disclosed in relation to the first embodiment, 6.1 and 6.2, each layer has substantially similar but not the same pitches (periods) in each of the layer (for a nonlimiting example, 11.5 μm×11.5 μm and 12 μm×12 μm). With such an attenuator the Vernier pattern will be observed in transmission with periodicity defined by the pore array periods in individual layers. Thus, the difference in pore array periods in individual layers should be preferably selected such as the Vernier patten period is substantially smaller than the cross-section of the detector or detector pixel. With such an attenuator design attenuation in excess of 1,000:1 can be readily achieved over the desired energy range. The method of fabrication of each layer of macroporous Si is essentially the same as discussed in relation to the first embodiment of the present invention. The advantage of such an attenuator design is very strong attenuation available particularly at low to medium particle or wave energies combined with relaxed alignment requirements between the layers in the attenuator, and simplicity of manufacturing (the same process is used for each layer in the stack, with just different photolithography patterning of the etch pit arrays). For a nonlimiting example of X-ray attenuator such a design is particularly advantageous for strong attenuation up to ˜200 KeV energy range.

Utilization of the pores with modulated diameters (achievable by modulating the current during the electrochemical etching of p-doped Si or by modulating the backside illumination intensity during the electrochemical etching of n-doped Si) is equally applicable for attenuators of all the embodiments of the present invention for applications where stray particles or waves reflected from the pore walls are undesirable, such as in the case of neutron or X-ray microscopy.

The charged particle, X-ray, gamma and/or thermal neutron attenuators of the present invention hold a number of advantages over the prior art attenuators: 1) simplicity of achieving extremely wide attenuation range (over 4 orders of magnitude) and wide energy range of uniform attenuation (for X-rays from few eV or even below to 100 s of keVs), 2) superior thermal stability, 3) cost effectiveness, 4) low mass, 5) superior mechanical stability. For a nonlimiting example of thin foils as most common X-ray attenuator material at present, the uniform attenuation is possible only from few keV up to at most few 10 s of keV, with everything below 1 keV being absorbed in the foil while everything above few 10 s of keV being transmitted. With attenuators of the present invention controllably attenuated transmission extends down to 1 eV or even below, while strong attenuation can be extended up to 100 s of keV.

Applications of charged particle, X-ray, gamma and/or thermal neutron attenuators of the present invention are expected in NASA missions (in telescopes), in medical radiology, microscopy, plasma studies, nuclear material detection and many more.

While the invention has been described in connection with what is presently considered to be the most practical and preferred embodiment, it is to be understood that the invention is not to be limited to the disclosed embodiments. Therefore, the metes and bounds of invention are defined by the claims—not by this specification—and are intended to cover various modifications and equivalent arrangements included within the scope of those claims.

What is claimed is:

1. An X-ray, gamma ray, charged particle and/or thermal neutron attenuator device comprising:
a semiconductor substrate or host wafer having an array of substantially uniform parallel hollow pores there through, the pores having characteristic lateral dimensions in the plane of the host wafer within the range of from about 0.1 μm to about 20 μm,
said wafer having first and second surfaces substantially perpendicular to the axis of the pores,
wherein the walls of each pore are conformally coated with at least one layer of material with atomic number higher than that of the host wafer, and wherein the thickness of each of said layers of transparent material is at least 10 nm, the thickness of semiconductor substrate is within the range of from about 50 μm to about 750 μm.

2. The X-ray, gamma ray, charged particle and/or thermal neutron attenuator device of claim 1, wherein the wafer is comprised at least partially of porous semiconductor material.

3. The X-ray, gamma ray, charged particle and/or thermal neutron attenuator device of claim 2, wherein the wherein said porous semiconductor material is macroporous silicon.

4. The X-ray, gamma ray, charged particle and/or thermal neutron attenuator device of claim 1, wherein the X-ray transmission at low X-ray energies is taking place though uncoated portion of the pore, while the X-rays passing through semiconductor host and/or pore wall coating are absorbed.

5. The X-ray, gamma ray, charged particle and/or thermal neutron attenuator device of claim 1, wherein the at least one layer of material conformally coating the pore walls is chosen from the group consisting of Ag, Al, Cu, Ni, Fe, Au, In, Ir, Sn, Pt, Pd, Rh, Ru, and conducting oxides, nitrides and oxynitrides of metals.

6. An X-ray, gamma ray, charged particle and/or thermal neutron attenuator device comprising:
At least two semiconductor substrates or host wafers positioned on the top of each other,
Wherein semiconductor substrates are having an arrays of substantially uniform parallel hollow pores there through, the pores having characteristic lateral dimensions in the plane of the host wafers substantially different between at least two host wafers by at least a factor of two between each pair of host wafers,
Wherein the pores in semiconductor substrates are within the range of from about 0.1 μm to about 20 μm,
said host wafers having first and second surfaces substantially perpendicular to the axis of the pores,
the thicknesses of semiconductor substrates are within the range of from about 50 μm to about 750 μm.

7. The X-ray, gamma ray, charged particle and/or thermal neutron attenuator device of claim 6 wherein the walls of each pore in at least one semiconductor substrate are conformally coated with at least one layer of material with atomic number higher than that of the host wafer, and wherein the thickness of each of said layers of transparent material is at least 10 nm.

8. The X-ray, gamma ray, charged particle and/or thermal neutron attenuator device of claim 6, wherein the host wafers is comprised at least partially of porous semiconductor material.

9. The X-ray, gamma ray, charged particle and/or thermal neutron attenuator device of claim 8, wherein the wherein said porous semiconductor material is macroporous silicon.

10. The X-ray, gamma ray, charged particle and/or thermal neutron attenuator device of claim 6, wherein the X-ray transmission at low X-ray energies is taking place though overlapped portions of the pores in individual substrates, while the X-rays passing through semiconductor hosts and/or pore wall coatings in each of the substrates are absorbed.

11. The X-ray, gamma ray, charged particle and/or thermal neutron attenuator device of claim 7, wherein the at least one layer of material conformally coating the pore walls in at least one semiconductor substrate is chosen from the group consisting of Ag, Al, Cu, Ni, Fe, Au, In, Ir, Sn, Pt, Pd, Rh, Ru, and conducting oxides, nitrides and oxynitrides of metals.

12. An X-ray, gamma ray, charged particle and/or thermal neutron attenuator device comprising:
At least two semiconductor substrates or host wafers positioned on the top of each other,
Wherein semiconductor substrates are having an arrays of substantially uniform parallel hollow pores there through, the pores having characteristic lateral dimensions in the plane of the host wafers substantially the same between at least two host wafers,
Wherein the pores in semiconductor substrates are within the range of from about 0.1 μm to about 20 μm,
Wherein said host wafers having first and second surfaces substantially perpendicular to the axis of the pores,
Wherein said pores are of regular shapes and are spatially ordered across said surfaces of the wafer thus forming ordered pore arrays,
Wherein said ordered pore arrays having spatial periodicity in the planes of said surfaces and this spatial periodicity is substantially the same on different host wafers,
Wherein said pore arrays in different host wafers are rotated with respect to each other in the planes of said surfaces by the angle in the range of 2° and 45°, the thicknesses of semiconductor substrates are within the range of from about 50 μm to about 750 μm.

13. The X-ray, gamma ray, charged particle and/or thermal neutron attenuator device of claim 12 wherein said ordered pore array order is chosen from the square and trigonal symmetry.

14. The X-ray, gamma ray, charged particle and/or thermal neutron attenuator device of claim 12 wherein the walls of each pore in at least one semiconductor substrate are conformally coated with at least one layer of material with atomic number higher than that of the host wafer, and wherein the thickness of each of said layers of transparent material is at least 10 nm.

15. The X-ray, gamma ray, charged particle and/or thermal neutron attenuator device of claim 12, wherein the host wafers is comprised at least partially of porous semiconductor material.

16. The X-ray, gamma ray, charged particle and/or thermal neutron attenuator device of claim 15, wherein the wherein said porous semiconductor material is macroporous silicon.

17. The X-ray, gamma ray, charged particle and/or thermal neutron attenuator device of claim 12, wherein the X-ray transmission at low X-ray energies is taking place though overlapped portions of the pores in individual substrates, while the X-rays passing through semiconductor hosts and/or pore wall coatings in each of the substrates are absorbed.

18. The X-ray, gamma ray, charged particle and/or thermal neutron attenuator device of claim 14, wherein the at least one layer of material conformally coating the pore walls in at least one semiconductor substrate is chosen from the group consisting of Ag, Al, Cu, Ni, Fe, Au, In, Ir, Sn, Pt, Pd, Rh, Ru, and conducting oxides, nitrides and oxynitrides of metals.

19. An X-ray, gamma ray, charged particle and/or thermal neutron attenuator device comprising:
At least two semiconductor substrates or host wafers positioned on the top of each other,
Wherein semiconductor substrates are having an arrays of substantially uniform parallel hollow pores there through, the pores having characteristic lateral dimensions in the plane of the host wafers substantially the same between at least two host wafers,
Wherein the pores in semiconductor substrates are within the range of from about 0.1 μm to about 20 μm,
Wherein said host wafers having first and second surfaces substantially perpendicular to the axis of the pores,
Wherein said pores are of regular shapes and are spatially ordered across said surfaces of the wafer thus forming ordered pore arrays,
Wherein said ordered pore arrays having spatial periodicity in the planes of said surfaces and this spatial periodicity is close but not the same on different host wafers, with the difference in periodicity in the range of 0.1% and 30% on different host wafers,
the thicknesses of semiconductor substrates are within the range of from about 50 μm to about 750 μm.

20. The X-ray, gamma ray, charged particle and/or thermal neutron attenuator device of claim 19 wherein said ordered pore array order is chosen from the square and trigonal symmetry.

21. The X-ray, gamma ray, charged particle and/or thermal neutron attenuator device of claim 19 wherein the walls of each pore in at least one semiconductor substrate are conformally coated with at least one layer of material with atomic number higher than that of the host wafer, and wherein the thickness of each of said layers of transparent material is at least 10 nm.

22. The X-ray, gamma ray, charged particle and/or thermal neutron attenuator device of claim 19, wherein the host wafers is comprised at least partially of porous semiconductor material.

23. The X-ray, gamma ray, charged particle and/or thermal neutron attenuator device of claim 22, wherein the wherein said porous semiconductor material is macroporous silicon.

24. The X-ray, gamma ray, charged particle and/or thermal neutron attenuator device of claim 19, wherein the X-ray transmission at low X-ray energies is taking place though overlapped portions of the pores in individual substrates, while the X-rays passing through semiconductor hosts and/or pore wall coatings in each of the substrates are absorbed.

25. The X-ray, gamma ray, charged particle and/or thermal neutron attenuator device of claim 21, wherein the at least one layer of material conformally coating the pore walls in at least one semiconductor substrate is chosen from the group consisting of Ag, Al, Cu, Ni, Fe, Au, In, Ir, Sn, Pt, Pd, Rh, Ru, and conducting oxides, nitrides and oxynitrides of metals.

26. The method of manufacturing of X-ray, gamma ray, charged particle and/or thermal neutron attenuator device comprising:
Providing a semiconductor substrate having first and second surface with said first surface being structured to achieve high aspect ratio,
Conformally coating said structured surface of a substrate with at least one layer of high atomic number material.

27. The method of claim 26 wherein said substrate contains a layer of porous semiconductor made by means of electrochemical etching.

28. A method of claim 26 wherein said high atomic number material conformal coating is coated by the method selected from the group consisted of chemical vapor deposition and atomic layer deposition.

29. The method of claim 26 wherein said high atomic number material conformal coating is coated by the wet electrochemical deposition.
